(19) United States
(12) Patent Application Publication
(10) Pub. No.: US 2026/0287083 A1
(43) Pub. Date: Sep. 24, 2026

(54) Control arrangement for a household appliance

(71) Applicants: BSH Home Appliances Corporation, Irvine, CA (US); BSH Hausgeräte GmbH, Munich (DE)

(72) Inventors: Eduardo Borbolla Jimenez, Boo de Piélagos (Cantabria) (ES); Cesar Aguado Vela, Camargo (ES); Roberto Carballo Fernandez, Santander (Cantabria) (ES); Carlos Pelayo Alonso, Villafufre (Cantabria) (ES)

(21) Appl. No.: 19/083,492

(22) Filed: Mar. 19, 2025

(51) Int. Cl. F16K 31/60; F24C 3/12

(52) U.S. Cl. CPC F16K 31/60; F24C 3/126

(57) ABSTRACT

A control arrangement is presented for a household appliance. The household appliance has a control panel, at least one opening through which a shaft can be coupled with a rotatable knob along a rotational axis. The control arrangement includes a receptacle part configured to accommodate the rotatable knob, the receptacle part having a central opening, and a coupling disk configured to mechanically couple to the control panel in a form-fit manner and configured to mechanically couple to the receptacle part in a form-fit manner. The coupling disk has a central opening, wherein the coupling disk and the rotatable knob are aligned along the rotational axis.

### FIELD

The present disclosure relates to the field of household appliances, specifically to mounting arrangements for control knobs used in various devices such as ovens, stoves, and gas hobs.

### INTRODUCTION

Control knobs are essential components that allow users to adjust settings and operate the appliance efficiently.

Since household appliances, including ovens, stoves, and gas hobs rely heavily on control knobs for user interaction, these knobs must be securely and accurately mounted to ensure reliable operation and user safety.

Control knobs for household appliances, such as a gas stove, may be manually rotated by an operator. The control knob may be connected to a shaft of the household appliance to transfer a torque to the shaft. For example, the shaft is connected to a gas valve of the gas stove, wherein a rotation of the control knob controls the gas supply to a cooking hob of the gas stove. The control knob may modify, by rotation, the amount of gas supplied to the cooking hob, thus modifying a flame size.

### SUMMARY

It is an objective of the present disclosure to provide an improved control arrangement for a household appliance.

According to a first aspect, a control arrangement for a household appliance with a control panel is provided. The control panel comprises at least one opening through which a shaft can be coupled with a rotatable knob along a rotational axis. The control arrangement comprises a receptacle part configured to accommodate the rotatable knob. The receptacle part comprises a central opening. The control arrangement further comprises a coupling disk. The coupling disk is configured to mechanically couple with the control panel in a form-fit manner and configured to mechanically couple with the receptacle part in a form-fit manner. The coupling disk comprises a central opening. The coupling disk and the rotatable knob are aligned along the rotational axis.

The coupling of a receptacle for the knob in terms of form-fit couplings with a coupling disk may give rise to at least one of the following beneficial aspects:
Precise alignment is ensured, eliminating the risk of misaligned knobs. This leads to accurate settings and a better user experience, enhancing the appliance's functionality and safety.
Installation is simplified and quick, requiring no screws or precise manual adjustments. This reduces installation time and the need for skilled labor, minimizing errors and ensuring consistent quality.
Production costs are reduced by eliminating screws and the need for precise alignment during assembly. Fewer components and steps in the assembly process make it easier to produce cost-effective appliances without compromising quality.
User convenience is enhanced with secure mounting, making it easier to clean and maintain household appliances. This reduces the likelihood of knobs becoming loose over time, preventing damage and the need for replacement parts.
Surface integrity is protected by avoiding the risk of damaging the appliance's panel surface, such as a stainless steel control panel. This prevents scratches or fissures, maintaining the panel's integrity and functionality.
Stability over time is ensured despite vibrations and thermal expansion and contraction. This ensures that the knob stays stable and safe, even with frequent heating and cooling cycles, enhancing user experience and safety.
Corrosion resistance is achieved, eliminating the risk of corrosion of screws and ensuring a durable and reliable coupling mechanism. This is particularly important for appliances like gas hobs, where a secure coupling is essential for safe operation.
The risk of over-tightening is avoided, which can damage the panel material. This ensures a stable and secure knob, reducing the need for repairs or replacements and preventing stress points that could lead to cracks or fractures.
Electronic components are protected from potential damage by screws, ensuring the appliance's internal components remain safe and functional.

In some examples, the coupling disk comprises an axial direction defined by the central axis through which the control shaft may extend, a radial direction extending outward from the central axis to the periphery of the disk, a circumferential direction extending around the periphery of the disk and a height defined as the distance between the two main surfaces of the disk along the axial direction. One may consider the coupling disk an interface between the receptacle part and the control panel.

In some examples, the mechanical form-fit coupling is implemented through a keyed disk and a corresponding keyed receptacle part or control panel. The disk may include protruding keys that fit into matching keyways in the receptacle part and the panel. The keys and keyways may be designed with an asymmetry ensuring that the disk can only be inserted in one orientation, providing a secure and precise fit. The interlocking mechanism can be considered similar to how typical Lego bricks fit together, where protrusions on one piece fit precisely into recesses of another piece and additionally hold through clamping. The keys and keyways ensure that there is no play between the parts, and rotational or axial movement is prevented. A tight interlocking mechanism ensures that the disk remains securely fixed in place, even under operational stresses.

In some examples, the mechanical coupling using a form-fit and potentially supported by clamping is, in embodiments, implemented through a bayonet coupling mechanism, where the disk features pins that engage with L-shaped slots in the receptacle part or the control panel. The disk is positioned such that its pins are inserted into the panel, and then the disk is rotated to lock the pins into place. The L-shaped slots are designed to guide the pins into a locked position, where they are held securely by the walls of the slots. The fit between the pins and the slots may give rise to frictional forces that resist unintended rotation.

The slots may be designed with tight tolerances to ensure that the pins fit snugly, creating an interference fit. This fit generates friction that holds the pins in place, preventing them from rotating back out of the locked position under normal operational conditions. Additionally, the horizontal section of the L-shaped slots can include detents or stops that the pins must overcome to rotate back. These detents are small protrusions or indentations within the slots that require additional force to move past.

In some examples, the coupling disk comprises at least one holding element extending axially from the coupling disk adapted to fit into an opening of the control panel and/or an opening of the receptacle part.

The at least one opening through which the at least one holding element extends may be connected to the central opening, i.e. the central opening and this at least one opening may be the same opening.

In this context, the term “opening” refers to any void, gap, or recess within a material or structure characterized by its shape, dimensions, and boundaries. This can include holes (circular, polygonal, elliptical or otherwise), notches, slots, or any other form of indentation or cavity.

In some examples, the at least one holding element comprises a first segment extending axially from the coupling disk, a second segment extending radially and/or circumferentially, and a third segment having a locking element facing the coupling disk.

In some examples, the control arrangement comprises the control panel.

In some examples, the receptacle part and/or control panel comprises a ramp facing away from the coupling disk, extending circumferentially, gradually increasing axially along its circumferential extension, in particular, including a fixation opening configured to accommodate the locking element.

In some examples, the holding element, in particular, the second segment, is configured to bend through rotation of the coupling disk around the rotational axis and thereby store elastic energy upon reaching the fixation opening where the locking element snaps in radial direction into the fixation opening.

In some examples, the ramp, the holding element, the locking element and the fixation opening are configured such that when rotating the receptacle part relative to the coupling disk during mounting there is an audible feedback, e.g. a click sound, when the locking element snaps into the fixation opening.

In some examples, as an alternative to using a ramp on the control panel and/or the coupling portion of the receptacle part to bend the holding element, the third segment of the holding element and the opening of the control panel and/or receptacle part, through which the first segment of the holding element extends axially, comprises rounded or tapered shapes.

In this configuration, the holding element, during an assembly process, is inserted through the opening in the (possibly flat) disk, wherein the rounded surfaces of both the third segment of the holding element and the opening of the control panel and/or receptacle part are configured such that the holding element is bent, thereby storing elastic energy. During rotation of the coupling disk with respect to the control panel and/or receptacle part, the stored elastic energy is maintained. The rotation may continue until the third segment of the holding element aligns with the corresponding fixation opening on the opposite side of the control panel and/or receptacle part. At this point, the stored elastic energy is released, causing the third segment of the holding element to snap into the corresponding fixation opening, thereby securing the connection. By utilizing the rounded shapes of the third segment of the holding element and the opening of the control panel and/or receptacle part, this approach effectively mimics the function of a ramp, allowing for a secure snap-fit without the need for an inclined surface on the disk itself.

In some examples, the cantilever snap-fit generates an audible and/or haptic feedback, e.g. the click sound and/or a counterforce or vibration, through the rapid release of stored elastic energy when the cantilever beam, which has been deflected during insertion, snaps back to its original or a new stable position. This snap action causes an impact between the beam and the mating part, creating vibrations that propagate as acoustic waves, producing the click sound. The force from this snap action is felt as haptic feedback. The intensity of the sound and feedback depends on the material stiffness, geometry, and dynamic interactions such as damping and resonance, which influence the vibration characteristics and energy release.

This kind of mechanical coupling through a form-fit is also referred to as a cantilever snap-fit.

In some examples, the mechanical coupling with a snap-fit is a cantilever snap-fit that involves at least one holding element on the disk that interacts with an opening in the panel and/or the receptacle part to create a secure connection: The disk may include one or more cantilevered holding elements, each comprising a base section axially attached to the disk, a section parallel to the main surfaces of the disk, and a locking element that bends to extend in an axial direction towards the disk.

The panel and/or receptacle part may have corresponding openings that allow the parallel sections of the holding elements to pass through. During the assembly process, the disk is rotated to align the holding elements with the openings in the panel through which the holding elements extend axially. As the disk continues to rotate, the snap-fit section of each holding element encounters a ramp that is part of the control panel or the receptacle part and extends circumferentially. This ramp may gradually increase in an axial direction and thereby deflecting the snap-fit section, causing it to flex and store elastic energy. This deflection is a controlled deformation that ensures the snap-fit section can pass the ramp without damage. Once the snap-fit section clears the ramp, it is released from deflection and returns, at least to some extent, to its original shape. This relaxation allows the snap-fit section to engage with an opening, for instance a notch or undercut, in the panel and/or receptacle part, creating a secure lock. The engagement between the snap-fit section and the opening prevents the holding element from moving, ensuring a reliable and stable connection. The design of the snap-fit section and the corresponding feature in the panel provides the necessary retention force to securely couple the coupling disk with the panel and/or receptacle part. The retention force is sufficient to withstand operational stresses, ensuring that the components remain fixed and stable during use.

The presented coupling mechanisms allow for easy assembly and disassembly, as the snap-fit mechanism can be disengaged by applying a controlled force to compress the snap-fit section and rotate the disk in the opposite direction.

In some examples, the coupling disk is configured to be removably coupled to the receptacle part and the control panel, such that it can be separated from both components without causing any damage to either of these components.

In some examples, the coupling disk is at least partially translucent.

Translucency is considered the physical property of a material that allows light (e.g., visible light) to pass through but scatters it due to internal variations in the refractive index. This scattering diffuses the light, preventing the formation of a clear image. Transparent materials are a special case of translucent materials where the scattering is minimal, allowing light (e.g., visible light) to pass through with little to no diffusion, thus enabling clear visibility of objects behind them. In contrast, non-transparent but translucent materials scatter light significantly, resulting in at most partial visibility of objects.

In some examples, the receptacle part is configured to accommodate a light source. This, in combination with the translucent coupling disc, may offer several advantages. First, the translucency of the disc ensures optimal light diffusion, providing a clear illumination that enhances the visibility of the control knob, even in low-light conditions. This is particularly beneficial for users who may need to operate the appliance in dimly lit environments, ensuring that the control settings are easily discernible. Additionally, the ability to mount the light source directly within the receptacle part allows for a compact design, eliminating the need for external indicator lights. This integration simplifies the user interface, making it more intuitive and thereby safer. Furthermore, the use of a removable coupling mechanism ensures that the coupling disk and the receptacle part can be detached without damage, facilitating easy maintenance and replacement of the light source if necessary. The primary functions of such a light include indicating the operational status of the appliance, providing feedback on temperature settings, and enhancing safety by clearly showing when the appliance is in use. In the present screw-free assembly shadows are prevented by avoiding the screws as obstacles for the light.

In some examples, the central opening of the coupling disk is axially tapered, and the central opening of the receptacle part has a matching conical shape configured to fit within the conical opening of the coupling disk.

This may assure and facilitate a precise alignment of the coupling disk and the receptacle part.

In some examples, the central opening of the coupling disk is conical with slanted sides that widen towards the receptacle part, following along a tapering angle from a first diameter at the front side of the disk to a smaller second diameter at the back side of the disk, and the central opening of the receptacle part has a matching conical shape configured to fit precisely within the conical opening of the coupling disk.

The term “conical” encompasses shapes where the apex of the conical form is not included (e.g., frustoconical shapes). Additionally, the base surface of the conical shape can be circular, polygonal, elliptical or take on other geometric forms.

In some examples, the control arrangement comprises the rotatable knob to be accommodated on the receptacle part.

According to a second aspect, a household appliance is provided. The household appliance comprises the control arrangement according to one of the previous embodiments and comprises the shaft, wherein the rotatable knob is operationally connected to the shaft, and wherein the rotatable knob is rotationally secured to the shaft.

The rotatable knob may be rotationally secured to the shaft by using methods like splines or keyways. Splines involve matching grooves on both the shaft and the knob that interlock, while keyways use a key that fits into slots on both parts. Another simple method is using a D-shaped shaft, where the flat side of the shaft fits into a corresponding flat section inside the knob, preventing rotation. To prevent the knob from moving axially along the shaft, a retaining ring or clip or similar mechanisms can be used.

A household appliance is a device or machine designed to assist with domestic tasks such as, for instance, cooking, baking, cleaning, and food preservation. These appliances can be powered by electricity, gas, or other energy sources. While commonly used in private residences, household appliances are also integral to professional environments such as restaurants and industrial kitchens. In particular, also industrial appliances like ranges, range tops, gas hobs are considered as household appliances.

Household appliances include, but are not limited to, a variety of cooking devices such as gas hobs, electric cooktops, induction ranges, range tops, ovens, microwaves, and slow cookers, as well as other appliances like refrigerators, dishwashers, washing machines and tumble dryers.

In some examples, the household appliance is a cooking device. In some examples, the household appliance is a gas hob.

According to a third aspect, a method for mounting is provided. The method comprises at least one of the following steps:
providing a control arrangement according to one of the described embodiments;
mechanically coupling the coupling disk to the receptacle part in a form-fit manner; and
mechanically coupling the coupling disk to the control panel in a form-fit manner.

In some examples, the method comprises at least one of the following steps:
providing a control arrangement according to one of the described embodiments;
positioning a first side of the coupling disk on the receptacle part such that at least one holding element extends through the corresponding opening of the receptacle part;
rotating the coupling disk with respect to the receptacle part until the locking element of the at least one holding element snaps into the corresponding fixation opening of the receptacle part;
positioning a side opposite to the first side of the coupling disk on the control panel such that at least one holding element extends through the corresponding opening of the control panel; and
rotating the coupling disk and the connected receptacle part with respect to the rotational axis until the locking element of the at least one holding element snaps into the corresponding fixation opening of the control panel.

The order of the steps may be different from the provided order.

Further possible implementations or alternative solutions of the disclosure also encompass combinations—that are not explicitly mentioned herein—of features described above or below with regard to the embodiments. The person skilled in the art may also add individual or isolated aspects and features to the most basic form of the disclosure.

It is understood that features of embodiments disclosed above with respect to one aspect or below with respect to the drawings and claims may also be employed in connection with other aspects of this disclosure.

The embodiments and features described with reference to the apparatus of the present disclosure apply mutatis mutandis to the method of the present disclosure.

Features, functions, and advantages may be achieved independently in various embodiments of the present disclosure, or may be combined in yet other embodiments, further details of which can be seen with reference to the following description and drawings.

### BRIEF DESCRIPTION OF THE DRAWINGS

Further embodiments, features and advantages of the present disclosure will become apparent from the subsequent description and dependent claims, taken in conjunction with the accompanying drawings, in which:

FIG. 1 is a schematic illustration of a household appliance;

FIG. 2 is a perspective view of a rotatable knob accommodated by a receptacle part;

FIG. 3 is a schematic cross-sectional view of a control arrangement according to an embodiment;

FIG. 4 is a perspective view of a control arrangement according to another embodiment;

FIG. 5 is an exploded perspective view of a control arrangement according to FIG. 4;

FIG. 6 is a schematic illustration of a part of a control arrangement according to an embodiment;

FIG. 7 is a schematic illustration of a method for mounting according to an embodiment;

FIG. 8 is a schematic illustration of a method for mounting according to an embodiment.

In the Figures, like reference numerals designate like or functionally equivalent elements, unless otherwise indicated.

### DETAILED DESCRIPTION

Various aspects and examples of a rotatable knob and control arrangement, as well as related methods, are described below and illustrated in the associated drawings. Unless otherwise specified, a knob or control arrangement in accordance with the present teachings, and/or its various components, may contain at least one of the structures, components, functionalities, and/or variations described, illustrated, and/or incorporated herein. Furthermore, unless specifically excluded, the process steps, structures, components, functionalities, and/or variations described, illustrated, and/or incorporated herein in connection with the present teachings may be included in other similar devices and methods, including being interchangeable between disclosed embodiments. The following description of various examples is merely illustrative in nature and is in no way intended to limit the disclosure, its application, or uses. Additionally, the advantages provided by the examples and embodiments described below are illustrative in nature and not all examples and embodiments provide the same advantages or the same degree of advantages.

The following definitions apply herein, unless otherwise indicated.

“Comprising,” “including,” and “having” (and conjugations thereof) are used interchangeably to mean including but not necessarily limited to, and are open-ended terms not intended to exclude additional, unrecited elements or method steps.

Terms such as “first”, “second”, and “third” are used to distinguish or identify various members of a group, or the like, and are not intended to show serial or numerical limitation.

“AKA” means “also known as,” and may be used to indicate an alternative or corresponding term for a given element or elements.

“Coupled” means connected, either permanently or releasably, whether directly or indirectly through intervening components.

“Providing,” in the context of a method, may include receiving, obtaining, purchasing, manufacturing, generating, processing, preprocessing, and/or the like, such that the object or material provided is in a state and configuration for other steps to be carried out.

In this disclosure, one or more publications, patents, and/or patent applications may be incorporated by reference. However, such material is only incorporated to the extent that no conflict exists between the incorporated material and the statements and drawings set forth herein. In the event of any such conflict, including any conflict in terminology, the present disclosure is controlling.

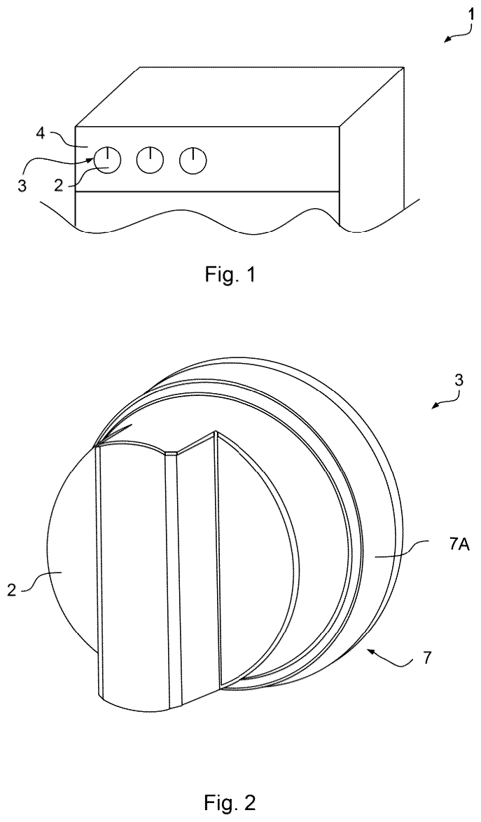

FIG. 1 is a schematic illustration of a gas hob as a household appliance 1. A control arrangement 3 is mounted to a control panel 4 on the front side (with respect to the orientation of FIG. 1) of the household appliance. A rotatable knob 2 is attached to the control arrangement 3. In some examples, the control panel 4, the control arrangement 3 and the rotatable knob 2 may also be positioned on the top side of the household appliance 1.

FIG. 2 shows a rotatable knob 2 suitable for use in the control arrangement 3 of FIG. 1. More specifically the rotatable knob is received in a sleeve portion 7A of a receptacle part 7. The knob 2 is partially accommodated by the receptacle part 7.

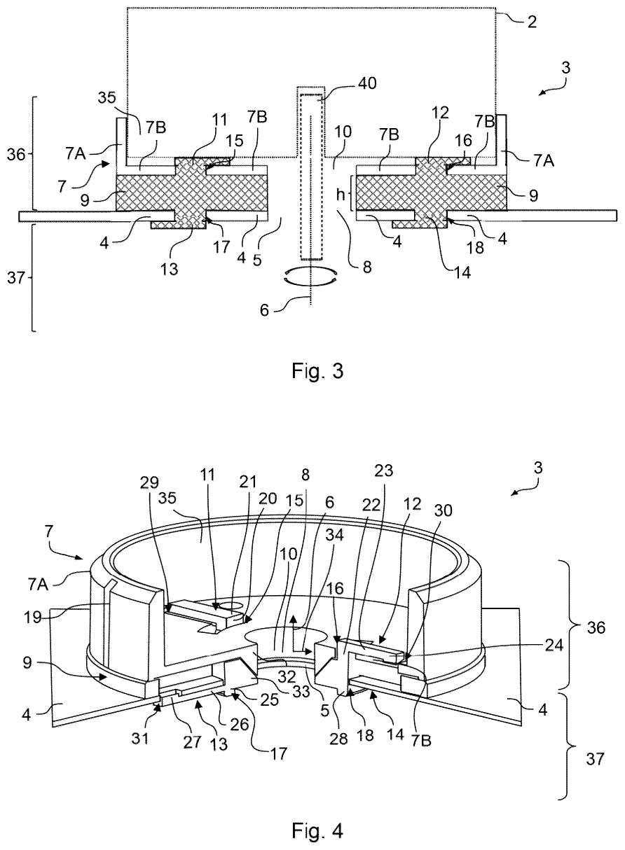

FIG. 3 shows a schematic view of a cross-section of the control arrangement 3 according to an embodiment. A coupling disk 9 (hashed) implements a coupling of the receptacle part 7 with the control panel 4 and is mechanically coupled to the control panel 4 and to the coupling portion 7B of the receptacle part 7. The control panel 4, the coupling disk 9 and the coupling portion 7B of the receptacle part 7 have central openings 5, 8 and 10 upon which they are aligned. The rotational axis 6 extends through these openings 5, 8 and 10, and a shaft 40 may be coaxial with axis 6. The mechanical coupling is implemented in a form-fit manner: The coupling disk has two outer holding elements 11 and 12 on its main surface directed away from the control panel 4 and two inner holding elements 13 and 14 on its main surface directed towards the control panel 4. The two pairs of holding elements 11, 12 and 13, 14 extend axially (with respect to the rotational axis 6) from the coupling disk 9. In particular, the outer holding elements 11 and 12 extend through axial openings 15 and 16 of the coupling portion 7B of the receptacle part 7 and the inner holding elements 13 and 14 extend through axial openings 17 and 18 of the control panel 4. The two pairs of holding elements 11, 12, and 13, 14 then further extend radially thereby establishing a form-fit with the coupling portion 7B and the control panel 4 respectively and thereby mechanically couple with the receptacle part 7 and the control panel 4 in a form-fit manner.

The form-fit between the coupling disk 9 and the coupling portion 7B of the receptacle part 7 is established since an axial movement is prevented as the coupling portion 7B of the receptacle part 7 is interlocked between the radial parts of the holding elements 11 and 12 of the coupling disk 9 and the main surface of the coupling disk 9 facing the receptacle part 7.

Similarly, the form-fit between the coupling disk 9 and the control panel 4 is established since an axial movement is prevented as the control panel 4 is interlocked between the radial parts of the holding elements 13 and 14 of the coupling disk 9 and the main surface of the coupling disk 9 facing the control panel 4. The sleeve portion 7A of the receptacle part 7 is configured to accommodate the rotatable knob 2 within the interior volume 35 of the receptacle part 7. The control panel 4 divides the space into an interior space 37 of the household appliance 1 (for instance a gas hob) and an opposite exterior space 36. The coupling disk 9 has a height h defined as the distance between its two main surfaces along the axial direction 6.

FIG. 4 shows another embodiment of the control arrangement 3 that can be used in the gas hob of FIG. 1. The coupling disk 9 is mechanically coupled to the control panel 4 and to the coupling portion 7B of the receptacle part 7. The control panel 4, the coupling disk 9 and the coupling portion 7B of the receptacle part 7 have central openings 5, 8 and 10 upon which they are aligned.

The central opening 8 of the coupling disk 9 is axially tapered, and the central opening of the coupling portion 7B of the receptacle part 7 has a matching conical shape configured to fit within the conical central opening 8 of the coupling disk 9. This allows for a precise alignment of both parts during mounting.

The rotational axis 6 extends through these openings 5, 8 and 10. The mechanical coupling is implemented in a form-fit manner as described above with respect to FIG. 3 and in the following: The two outer holding elements 11 and 12 each comprise three segments: A first segment 20 and 22 extending axially from the coupling disk 9 through openings 15 and 16 of the coupling portion 7B of the receptacle part 7, extending to a second segment 21 and 23 in radial direction (for instance in radial direction 34) and further extending to a third segment 24 (the other third segment is covered and hence not depicted in FIG. 4) facing the coupling disk 9.

Similarly, the two inner holding elements 13 and 14 also each comprise three segments: A first segment 25 and 28 extending axially from the coupling disk 9 through openings 17 and 18 of the control panel, extending to a second segment 26 (the other second segment is covered and hence not depicted in FIG. 4) parallel to the coupling disk, and further extending to a third segment 27 (the other third segment is covered and hence not depicted in FIG. 4) facing the coupling disk 9. The third segments 24 of the outer holding elements 11 and 12 fit into corresponding fixation openings 29 and 30 in the coupling portion 7B from that side of the coupling portion 7B of the receptacle part 7 that faces away from the control panel.

Thereby a form-fit is established regarding axial, circumferential and radial movements of the receptacle part 7 with respect to the coupling disk 9.

Similarly, the third segments 24 of the inner holding elements 13 and 14 fit into corresponding fixation openings 31 (the other fixation opening is covered and hence not depicted in FIG. 4) in the control panel 4 from that side of the control panel 4 that faces away from exterior space 36 and towards the interior space 37. The sleeve portion 7A of the receptacle part 7 comprises a groove 19 that functions to indicate the position where the rotatable knob 2 must be aligned in the off position of the household appliance 1.

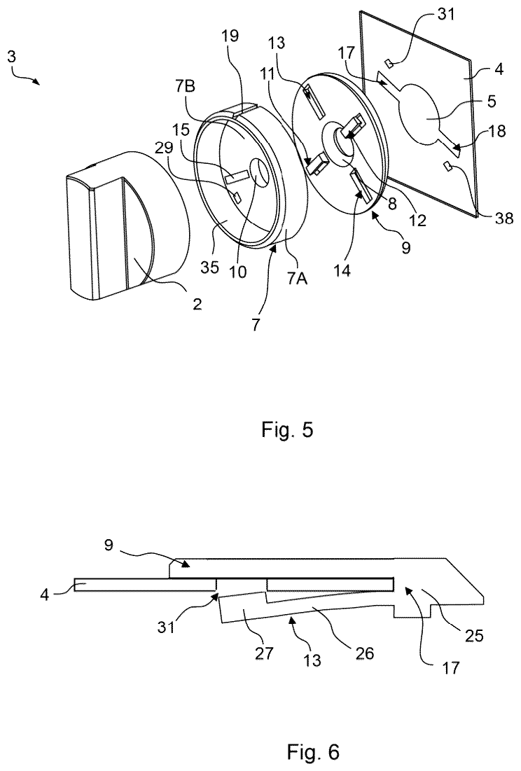

FIG. 5 shows an exploded view of the control arrangement 3 of FIG. 4. The control panel 4 has the central opening 5 (also referred to as aperture 5) and fixation openings 31 and 38. The coupling disk 9 comprises the two inner holding elements 13 and 14 on that side that is facing towards the control panel 4, which are configured to fit into openings 17, 18 of the control panel 4 and then, by means of rotation, latch into corresponding fixation openings 31, 38 of the control panel 4, thereby mechanically coupling the coupling disk 9 and the control panel 4 by means of a cantilever snap-fit mechanism.

The coupling disk 9 also comprises the two outer holding elements 11, 12 on that side that is facing away from the control panel 4, which are configured to fit into respective openings 15, 16 of the coupling portion 7B of the receptacle part 7 and then, by means of rotation, latch into corresponding fixation openings 29, 30 of the receptacle part, thereby mechanically coupling the coupling disk 9 and the receptacle part 7 by means of a cantilever snap-fit mechanism. The receptacle part 7 comprises a groove 19 that indicates the position where the rotatable knob 2 must be aligned in the off position.

FIG. 6 is a schematic illustration of the coupling disk 9 of FIG. 4 left (dotted area indicated), inner holding element 13 of the coupling disk 9 and the control panel 4 in a state before the third segment 27 of holding element 13 will snap into the fixation opening 31. The holding element 13 comprises the three segments, the first segment 25 extending axially through the opening 17 of the control panel 4, the second segment 26 extending radially, and the third segment 27 extending axially towards the coupling disk 9. The second segment 26 of the holding element 13 is bent, thereby storing elastic energy which will be released upon further rotation of the coupling disk 9 with respect to the control panel 4 when the third segment 27 of the holding element 13 snaps into the fixation opening 31. A click sound of the snapping gives an audible feedback, for example.

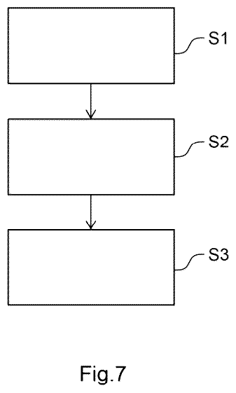

FIG. 7 indicates steps of a method for mounting the control arrangement according to an embodiment: In a first step S1, the elements of a control arrangement according to the described embodiments is provided.

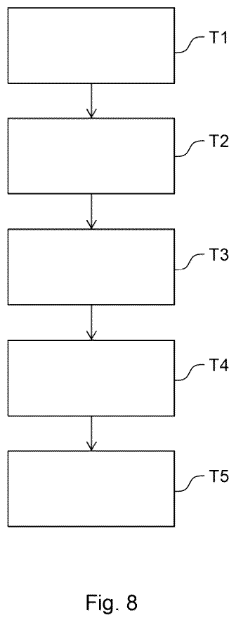

In a second step S2, the coupling disk 9 is mechanically coupled to the receptacle part 7 in a form-fit manner. In a third step S3, the coupling disk 9 is mechanically coupled to the control panel 4 in a form-fit manner. FIG. 8 indicates the method steps in a more detailed fashion: In a first step T1, the elements of a control arrangement 1 according to the described embodiments is provided.

In a second step T2, a first side of the coupling disk 9 is positioned on the receptacle part 7 such that at least one holding element 11, 12 extends through the corresponding opening 15, 16 of the coupling portion 7B of the receptacle part 7. This is illustrated in FIG. 5, for example.

In a third step T3, the coupling disk 9 is rotated with respect to the receptacle part 7 until the locking element of the at least one holding element 11, 12 snaps into the corresponding fixation opening 29, 30 of the coupling portion 7B of the receptacle part 7 as explained with respect to FIGS. 3, 4 and 6. In a fourth step T4, a side of the coupling disk 9 opposite to the first side is positioned on the control panel 4 such that at least one holding element 13, 14 extends through the corresponding opening 17, 18 of the control panel 4.

In a fifth step T5, the coupling disk 9 and the connected receptacle part 7 are rotated with respect to the rotational axis 6 until the locking element of the at least one holding element 13, 14 snaps into the corresponding fixation opening 31 of the control panel 4.

As a result, an assembled control arrangement, e.g. shown in FIG. 4 is obtained. The control arrangement 3 is ready to receive the control knob (FIGS. 2 and 3).

Terms like axially, radially, parallel, orthogonal and the like are to be interpreted with suitable tolerances. For instance, each orientation may be considered with an allowable deviation range of 0 to 5 degrees. In other embodiments, the allowable deviation range may be 0 to 10 degrees.

The disclosed control arrangements for household appliances may facilitate the mounting of control knobs. Conventional methods of securing control knobs typically involve the use of screws, which presents several drawbacks. These include labor-intensive installation processes, the propensity for screws to loosen over time, and the potential for damage to the appliance surface during installation or removal. The control arrangement described herein enables a screw-free, form-fit attachment mechanism that ensures a secure and straightforward installation, reducing assembly time and eliminating the risk of surface damage.

In summary, a control arrangement (3) for a household appliance (1) is presented. The household appliance (1) has a control panel (4) at least one opening (5) through which a shaft (40) can be coupled with a rotatable knob (2) along a rotational axis (6). The control arrangement (3) comprises a receptacle part (7) configured to accommodate the rotatable knob (2), the receptacle part (7) comprising a central opening (10), and a coupling disk (9) configured to mechanically couple with the control panel (4) in a form-fit manner and configured to mechanically couple with the receptacle part (7) in a form-fit manner. The coupling disk (9) comprises a central opening (8), wherein the coupling disk (9) and the rotatable knob (2) are aligned along the rotational axis (6).

List of reference signs:

| | |
|---|---|
| 1 | household appliance |
| 2 | rotatable knob |
| 3 | control arrangement |
| 4 | control panel |
| 5 | central opening of the control panel |
| 6 | rotational axis |
| 7 | receptacle part |
| 7A | sleeve portion of the receptacle part |
| 7B | coupling portion of the receptacle part |
| 8 | central opening of the coupling disk |
| 9 | coupling disk |
| 10 | central opening of the receptacle part |
| 11, 12 | outer holding elements |
| 13, 14 | inner holding elements |
| 15, 16, 17, 18 | openings |
| 19 | groove |
| 20 | first segment of holding element 11 |
| 21 | second segment of holding element 11 |
| 22 | first segment of holding element 12 |
| 23 | second segment of holding element 12 |
| 24 | third segment of holding element 12 |
| 25 | first segment of holding element 13 |
| 26 | second segment of holding element 13 |
| 27 | third segment of holding element 13 |
| 28 | first segment of holding element 14 |
| 29, 30, 31, 38 | fixation opening |
| 32 | axially tapered part of receptacle part |
| 33 | axially tapered part of coupling disk |
| 34 | radial direction |
| 35 | inner volume of the receptacle part |
| 36 | exterior space with respect to |
| | control panel of household appliance |
| 37 | interior space with respect to |
| | control panel of household appliance |
| S1-S3 | Steps 1-3 of a method for mounting |
| | according to one embodiment |
| T1-T5 | Steps 1-5 of a method for mounting |
| | according to one embodiment |
| h | height of the coupling disk |

The following enumerated paragraphs describe additional aspects and features of the systems and methods disclosed herein.

A0. A control arrangement (3) for a household appliance (1) with a control panel (4) comprising at least one opening (5) through which a shaft (40) can be coupled with a rotatable knob (2) along a rotational axis (6), the control arrangement (3) comprising:
a receptacle part (7) configured to accommodate the rotatable knob (2), the receptacle part (7) comprising a central opening (10); and
a coupling disk (9) configured to mechanically couple with the control panel (4) in a form-fit manner and configured to mechanically couple with the receptacle part (7) in a form-fit manner, the coupling disk (9) comprising a central opening (8), wherein the coupling disk (9) and the rotatable knob (2) are aligned along the rotational axis (6).

A1. The control arrangement (3) according to A0, wherein the coupling disk (9) comprises at least one holding element (11, 12, 13, 14) extending axially from the coupling disk (9) adapted to fit into an opening (15, 16) of the control panel (4) and/or an opening (17, 18) of the receptacle part (7).

A2. The control arrangement (3) according to A1, wherein the at least one holding element (11, 12, 13, 14) comprises a first segment (20, 22, 25, 28) extending axially from the coupling disk (9), a second segment (21, 23, 26) extending radially and/or circumferentially, and a third segment (24, 27) having a locking element facing the coupling disk (9).

A3. The control arrangement (3) according to one of paragraphs A0 through A2, comprising the control panel (4).

A4. The control arrangement (3) according to A3, wherein the receptacle part (7) and/or control panel (4) comprises a ramp facing away from the coupling disk, extending circumferentially, gradually increasing axially along its circumferential extension, in particular including a fixation opening (29, 30, 31) configured to accommodate the locking element.

A5. The control arrangement (3) according to A4, wherein the holding element (11, 12, 13, 14), in particular the second segment (21, 23, 26), is configured to bend through rotation of the coupling disk (9) around the rotational axis (6) and thereby store elastic energy upon reaching the fixation opening (29, 30, 31) where the locking element snaps in radial direction into the fixation opening (29, 30, 31).

A6. The control arrangement (3) according to A4 or A5, wherein the ramp, the holding element (11, 12, 13, 14), the locking element and the fixation opening (29, 30, 31) are configured such that when rotating the receptacle part (7) relative to the coupling disk (9) during mounting there is a click sound when the locking element snaps into the fixation opening (29, 30, 31).

A7. The control arrangement (3) according to any one of paragraphs A0 through A6, wherein the coupling disk (9) is configured to be removably coupled to the receptacle part (7) and the control panel (4), such that it can be separated from both components without causing any damage to either of these components.

A8. The control arrangement (3) according to any one of paragraphs A0 through A7, wherein the coupling disk (9) is at least partially translucent.

A9. The control arrangement (3) according to any one of paragraphs A0 through A8, wherein the central opening (8) of the coupling disk (9) is axially tapered, and wherein the central opening (10) of the receptacle part (7) has a matching conical shape configured to fit within the conical opening (8) of the coupling disk (9). A10. The control arrangement (3) according to any one of paragraphs A0 through A9, comprising the rotatable knob (2) to be accommodated on the receptacle part (7). A11. A household appliance (1) comprising the control arrangement (3) according to any one of paragraphs A0 through A10 and comprising the shaft, wherein the rotatable knob (2) is operationally connected to the shaft, and wherein the rotatable knob (2) is rotationally secured to the shaft.

A12. The household appliance (1) according to A11, wherein the household appliance (1) is a gas hob.

A13. A method for mounting, comprising:
providing (S1) a control arrangement (3) according to any one of paragraphs A0 through A9;
mechanically coupling (S2) the coupling disk (9) to the receptacle part (7) in a form-fit manner; and
mechanically coupling (S3) the coupling disk (9) to the control panel (4) in a form-fit manner.

A14. The method for mounting according to A13, comprising:
providing (T1) a control arrangement (3) according to any one of paragraphs A4 through A9;
positioning (T2) a first side of the coupling disk (9) on the receptacle part (7) such that at least one holding element (11, 12) extends through the corresponding opening (15, 16) of the receptacle part (7);
rotating (T3) the coupling disk (9) with respect to the receptacle part (7) until the locking element of the at least one holding element (11, 12) snaps into the corresponding fixation opening (29, 30) of the receptacle part (7);
positioning (T4) a side opposite to the first side of the coupling disk (9) on the control panel (4) such that at least one holding element (13, 14) extends through the corresponding opening (17, 18) of the control panel (4); and
rotating (T5) the coupling disk (9) and the connected receptacle part (7) with respect to the rotational axis (6) until the locking element of the at least one holding element (13, 14) snaps into the corresponding fixation opening (31) of the control panel (4).

B0. A control arrangement for a household appliance having a control panel comprising at least one aperture through which a shaft can be coupled to a rotatable knob along a rotational axis, the control arrangement comprising:
a receptacle part configured to accommodate the rotatable knob, the receptacle part comprising a first central opening; and
a coupling disk configured to mechanically couple to the control panel in a form-fit manner and configured to mechanically couple to the receptacle part in a form-fit manner, the coupling disk comprising a second central opening, wherein the second central opening of the coupling disk and the first central opening of the rotatable knob are aligned coaxially along the rotational axis.

B1. The control arrangement according to B0, wherein the coupling disk comprises at least one holding element extending axially from the coupling disk, wherein the at least one holding element is configured to fit into a corresponding first opening of the control panel and/or a corresponding second opening of the receptacle part.

B2. The control arrangement according to B1, wherein the at least one holding element comprises a first segment extending axially from the coupling disk, a second segment extending radially and/or circumferentially, and a third segment having a locking element facing the coupling disk.

B3. The control arrangement according to B2, wherein the receptacle part comprises a ramp facing away from the coupling disk, extending circumferentially, gradually increasing axially along a circumferential extension, the ramp including a fixation opening configured to accommodate the locking element.

B4. The control arrangement according to B3, wherein the second segment of the holding element is configured to bend through rotation of the coupling disk around the rotational axis and to store elastic energy upon reaching the fixation opening where the locking element snaps in a radial direction into the fixation opening.

B5. The control arrangement according to B3, wherein the ramp, the holding element, the locking element, and the fixation opening are configured such that rotating the receptacle part relative to the coupling disk during mounting causes a click sound when the locking element snaps into the fixation opening.

B6. The control arrangement according to B2, further comprising the control panel.

B7. The control arrangement according to B6, wherein the control panel comprises a ramp facing away from the coupling disk, extending circumferentially, gradually increasing axially along a circumferential extension, the ramp including a fixation opening configured to accommodate the locking element.

B8. The control arrangement according to B7, wherein the second segment of the holding element is configured to bend through rotation of the coupling disk around the rotational axis and to store elastic energy upon reaching the fixation opening where the locking element snaps in radial direction into the fixation opening.

B9. The control arrangement according to B7, wherein the ramp, the holding element, the locking element, and the fixation opening are configured such that rotating the receptacle part relative to the coupling disk during mounting causes a click sound when the locking element snaps into the fixation opening.

B10. The control arrangement according to any one of paragraphs B0 through B9, wherein the coupling disk is configured to be removably coupled to the receptacle part and the control panel, such that the coupling disk, the receptacle part, and the control panel are configured to be selectively and repeatedly separated and recoupled without damage or destruction.

B11. The control arrangement according to one of paragraphs B0 through B10, wherein at least a portion of the coupling disk is translucent.

B12. The control arrangement according to one of paragraphs B0 through B11, wherein the second central opening of the coupling disk is axially tapered, and wherein the first central opening of the receptacle part has a conforming conical shape configured to fit within the second central opening of the coupling disk.

B13. The control arrangement according to one of paragraphs B0 through B12, further comprising the rotatable knob, wherein the knob is accommodated on the receptacle part.

B14. A household appliance comprising the control arrangement according to one of paragraphs B0 through B13, and comprising the shaft, wherein the rotatable knob is rotationally secured to the shaft.

B15. The household appliance according to B14, wherein the household appliance is a gas hob.

C0. A method for mounting, comprising:
mounting the control arrangement of any one of paragraphs B0 through B13 to a control panel;
wherein mounting the control arrangement includes mechanically coupling the coupling disk to the receptacle part in a form-fit manner, and mechanically coupling the coupling disk to the control panel in a form-fit manner.

D0. A method for mounting, comprising:
mounting the control arrangement of one of paragraphs B7 through B9 to the control panel;
wherein mounting the control arrangement includes:
   mechanically coupling the coupling disk to the receptacle part in a form-fit manner, and mechanically coupling the coupling disk to the control panel in a form-fit manner;
   positioning a first side of the coupling disk on the receptacle part such that at least one holding element extends through the corresponding opening of the receptacle part;
   rotating the coupling disk with respect to the receptacle part until the locking element of the at least one holding element snaps into the corresponding fixation opening of the receptacle part;
   positioning a side opposite to the first side of the coupling disk on the control panel such that at least one holding element extends through the corresponding opening of the control panel; and
   rotating the coupling disk and the connected receptacle part with respect to the rotational axis until the locking element of the at least one holding element snaps into the corresponding fixation opening of the control panel.

### CONCLUSION

The disclosure set forth above may encompass multiple distinct examples with independent utility. Although each of these has been disclosed in its preferred form(s), the specific embodiments thereof as disclosed and illustrated herein are not to be considered in a limiting sense, because numerous variations are possible. To the extent that section headings are used within this disclosure, such headings are for organizational purposes only. The subject matter of the disclosure includes all novel and nonobvious combinations and subcombinations of the various elements, features, functions, and/or properties disclosed herein. The following claims particularly point out certain combinations and subcombinations regarded as novel and nonobvious. Other combinations and subcombinations of features, functions, elements, and/or properties may be claimed in applications claiming priority from this or a related application. Such claims, whether broader, narrower, equal, or different in scope to the original claims, also are regarded as included within the subject matter of the present disclosure.

1. A control arrangement for a household appliance having a control panel comprising at least one aperture through which a shaft can be coupled to a rotatable knob along a rotational axis, the control arrangement comprising:
a receptacle part configured to accommodate the rotatable knob, the receptacle part comprising a first central opening; and
a coupling disk configured to mechanically couple to the control panel in a form-fit manner and configured to mechanically couple to the receptacle part in a form-fit manner, the coupling disk comprising a second central opening, wherein the second central opening of the coupling disk and the first central opening of the rotatable knob are aligned coaxially along the rotational axis.

2. The control arrangement according to claim 1, wherein the coupling disk comprises at least one holding element extending axially from the coupling disk, wherein the at least one holding element is configured to fit into a corresponding first opening of the control panel and/or a corresponding second opening of the receptacle part.

3. The control arrangement according to claim 2, wherein the at least one holding element comprises a first segment extending axially from the coupling disk, a second segment extending radially and/or circumferentially, and a third segment having a locking element facing the coupling disk.

4. The control arrangement according to claim 3, wherein the receptacle part comprises a ramp facing away from the coupling disk, extending circumferentially, gradually increasing axially along a circumferential extension, the ramp including a fixation opening configured to accommodate the locking element.

5. The control arrangement according to claim 4, wherein the second segment of the holding element is configured to bend through rotation of the coupling disk around the rotational axis and to store elastic energy upon reaching the fixation opening where the locking element snaps in a radial direction into the fixation opening.

6. The control arrangement according to claim 4, wherein the ramp, the holding element, the locking element, and the fixation opening are configured such that rotating the receptacle part relative to the coupling disk during mounting causes a click sound when the locking element snaps into the fixation opening.

7. The control arrangement according to claim 3, further comprising the control panel.

8. The control arrangement according to claim 7, wherein the control panel comprises a ramp facing away from the coupling disk, extending circumferentially, gradually increasing axially along a circumferential extension, the ramp including a fixation opening configured to accommodate the locking element.

9. The control arrangement according to claim 8, wherein the second segment of the holding element is configured to bend through rotation of the coupling disk around the rotational axis and to store elastic energy upon reaching the fixation opening where the locking element snaps in radial direction into the fixation opening.

10. The control arrangement according to claim 8, wherein the ramp, the holding element, the locking element, and the fixation opening are configured such that rotating the receptacle part relative to the coupling disk during mounting causes a click sound when the locking element snaps into the fixation opening.

11. The control arrangement according to claim 1, wherein the coupling disk is configured to be removably coupled to the receptacle part and the control panel, such that the coupling disk, the receptacle part, and the control panel are configured to be selectively and repeatedly separated and recoupled without damage or destruction.

12. The control arrangement according to claim 1, wherein at least a portion of the coupling disk is translucent.

13. The control arrangement according to claim 1, wherein the second central opening of the coupling disk is axially tapered, and wherein the first central opening of the receptacle part has a conforming conical shape configured to fit within the second central opening of the coupling disk.

14. The control arrangement according to claim 1, further comprising the rotatable knob, wherein the knob is accommodated on the receptacle part.

15. A household appliance comprising the control arrangement according to claim 1, and comprising the shaft, wherein the rotatable knob is rotationally secured to the shaft.

16. The household appliance according to claim 15, wherein the household appliance is a gas hob.

17. A method for mounting, comprising:
mounting the control arrangement of claim 1 to a control panel;
wherein mounting the control arrangement includes mechanically coupling the coupling disk to the receptacle part in a form-fit manner, and mechanically coupling the coupling disk to the control panel in a form-fit manner.

18. A method for mounting, comprising:
mounting the control arrangement of claim 8 to the control panel;
wherein mounting the control arrangement includes:
mechanically coupling the coupling disk to the receptacle part in a form-fit manner, and mechanically coupling the coupling disk to the control panel in a form-fit manner;
positioning a first side of the coupling disk on the receptacle part such that at least one holding element extends through the corresponding opening of the receptacle part;
rotating the coupling disk with respect to the receptacle part until the locking element of the at least one holding element snaps into the corresponding fixation opening of the receptacle part;
positioning a side opposite to the first side of the coupling disk on the control panel such that at least one holding element extends through the corresponding opening of the control panel; and
rotating the coupling disk and the connected receptacle part with respect to the rotational axis until the locking element of the at least one holding element snaps into the corresponding fixation opening of the control panel.
